(19) United States
(12) Patent Application Publication
(10) Pub. No.: US 2026/0219487 A1
(43) Pub. Date: Jul. 30, 2026

(54) Quantitative Wide Field Polarized Light Microscope

(71) Applicant: Advanced Optical Technologies, Inc., Albuquerque, NM (US)

(72) Inventors: Brian G. Hoover, Tijeras, NM (US); Jonathan H. Turner, Albuquerque, NM (US); Cesar Ornelas-Rascon, Albuquerque, NM (US)

(73) Assignee: Advanced Optical Technologies, Inc., Albuquerque, NM (US)

(21) Appl. No.: 19/039,494

(22) Filed: Jan. 28, 2025

Related U.S. Application Data
(63) Continuation of application No. PCT/US2023/029123, filed on Jul. 31, 2023.
(60) Provisional application No. 63/393,670, filed on Jul. 29, 2022.

(51) Int. Cl. G02B 21/00; G02B 21/36

(52) U.S. Cl. CPC G02B 21/0092; G02B 21/361; G02B 21/365

(57) ABSTRACT

An embodiment of the present invention provides for a polarized-light microscope (PLM) in an unconventional bistatic configuration that avoids aberrations that limit the field-of-view (FOV) of conventional PLMs. An embodiment of the PLM provides one or more of a polarization FOV, with accuracy better than 5% overall elemental error of measured Mueller-matrix elements, over 200× larger than those of conventional PLMs, for both reflective and transmissive samples. A further embodiment provides a method to achieve unlimited polarization FOV for reflective samples by stitching together micrographs obtained as the sample or the microscope is translated, without suffering from seam discontinuities that arise when stitching micrographs of conventional PLMs without digital blending. Embodiments described herein achieve analytical or quantitative wide-field polarized-light microscopy applicable, with suitable models, to characterization of material structures, microstructures, and textures, for instance those associated with crystallographic structure and the resulting micrographs produced therefrom.

### CROSS-REFERENCE TO RELATED APPLICATIONS

This application is a continuation application PCT/US2023/029123, entitled “Quantitative Wide Field Polarized Light Microscope”, filed on Jul. 31, 2023, which claims priority to and the benefit of the filing of U.S. Provisional Ser. No. 63/393,670 , entitled “Quantitative Wide Field Polarized Light Microscope”, filed on Jul. 29, 2022, and the specification and claims thereof are incorporated herein by reference.

### STATEMENT REGARDING FEDERALLY SPONSORED RESEARCH OR DEVELOPMENT

Not Applicable.

### THE NAMES OF PARTIES TO A JOINT RESEARCH AGREEMENT

Not Applicable.

### INCORPORATION BY REFERENCE OF MATERIAL SUBMITTED ON A COMPACT DISC

Not Applicable.

### STATEMENT REGARDING PRIOR DISCLOSURES BY THE INVENTOR OR A JOINT INVENTOR

Not Applicable.

### COPYRIGHTED MATERIAL

Not Applicable.

### BACKGROUND OF THE INVENTION

### Field of the Invention (Technical Field)

Embodiments of the present invention are related to the field of optical microscopy, and more specifically polarized-light microscopy (PLM) for imaging material structures, microstructures, and textures that may be due, for instance, to crystallographic structure. One embodiment of the present invention is a laser-based polarized-light microscope with a large field-of-view (FOV) in terms of resolution and polarization accuracy. Embodiments of the present invention are also in the field of analytical or quantitative microscopy as applied to material characterization. Material properties that can be imaged and measured include one or more of the following: material chemistry, phase, crystallinity, topography, grain or fiber size and shape, crystal or fiber orientation, stress, and their spatial and temporal distributions.

### Description of Related Art Including Information Disclosed Under 37 C.F.R. § § 1.97 and 1.98

Note that the following discussion refers to a number of publications by author(s) and year of publication, and that due to recent publication dates certain publications are not to be considered as prior art vis-a-vis the present invention. Discussion of such publications herein is given for more complete background and is not to be construed as an admission that such publications are prior art for patentability determination purposes.

Accurate examination and imaging using polarized light has enabled a diversity of material characterization techniques, for instance in the fields of crystallography, metallography, chiral and polymer analysis, thin films, nanotechnology, and tissue and cellular biology. Techniques are considered quantitative if measured polarization features can be verified against independent measurements or first-principal models, usually by application of a model that relates the measured polarization features to other material features or properties that can be measured by an independent instrument.

Polarization features are combinations of measurable optical powers, combinations of irradiances in the case of imaging. In metallography, for instance, as demonstrated in Journal of the Optical Society of America A 38, 1752 (2021), measured polarized-image irradiances can be applied to estimate crystal orientation, through application of an electrodynamic model, with the measured polarization features verified by comparison of derived crystal orientations with those measured by electron-backscatter diffraction (EBSD) implemented on a scanning electron microscope (SEM).

When applied to characterize microstructures through verified measurements, PLM is termed analytical or quantitative polarized-light microscopy (qPLM). Techniques as applied to qPLM for obtaining polarization images of microstructures can also be applied to polarization imaging of larger objects at longer ranges. Microscopy is the technical field of using microscopes to view samples and objects that cannot be seen with the unaided eye. While PLM has been utilized for nearly a century to visualize anisotropic microstructures, qPLM is relatively new, primarily because it utilizes digital image processing and accurate polarization metrology and polarization optics that can be difficult to obtain and qualify. Very few commercial optical microscopes can achieve qPLM over field radii larger than several mm. Ellipsometry, on the other hand, has traditionally been quantitative, but non-imaging, primarily because it relies on a large (typically 50-60 degree) oblique angle-of-incidence that precludes imaging over areas greater than about 1 mm². This limitation renders ellipsometry not useful for imaging larger areas (for example areas between about greater than 1 mm² to about 225 mm² or greater) unless multiple images are stitched together to capture the larger area to be imaged. Most ellipsometers employ a broadband white light source and measure polarized intensity at different colors/wavelengths, so the optimal optical design and components, with low polarization aberrations, for ellipsometers are different from those for a laser PLM microscope, like one or more embodiments of the present invention, that measure polarized image irradiance at a single or small number of wavelengths. Imaging ellipsometers have been demonstrated, for instance in U.S. Pat. No. 7,663,752, only with FOVs substantially smaller than 1 mm².

Microscope images or micrographs are specified by several primary parameters: spatial resolution, field-of-view (FOV), and image quality, which can include signal-to-noise ratio (SNR). Accuracy is also critical for quantitative microscopy. For conventional optical microscopes as well as embodiments of the present invention, the spatial resolution, image quality, and accuracy all vary with the FOV, typically highest at the center of the image and decreasing for wider field points. Loss of resolution and accuracy with increasing FOV is caused primarily by aberrations that increase with the field angle relative to the optical axis. A field stop is usually employed to limit the micrograph to a FOV over which the aberrations are tolerable, and resolution and accuracy are specified as their values at the periphery of this FOV. It is also common, although misleading, to specify microscope resolution and accuracy at the center of the micrograph while specifying a larger FOV. Polarization accuracy is especially difficult to maintain to larger FOVs, with most commercial microscopes limited to around 1 mm² polarization FOV, although brightfield/unpolarized FOVs can be larger. Attempts have been made to correct aberrations in conventional PLMs, to extend polarization accuracy to FOVs larger than several mm², but results have been inconsistent and are not applicable to the microscope of the present invention, which uses a fundamentally different bistatic configuration.

Quantitative microscopy requires high absolute accuracy, as defined for polarimetry below, since material variations of interest often correspond to only small changes in reflected or transmitted light. For instance, as shown in Journal of the Optical Society of America A 38, 1752 (2021), variations of crystal orientation in titanium alloys correspond to a maximum variation of less than 5% in the polarized reflectivity at visiblewavelengths. Other materials of interest have even smaller fractional anisotropies resulting in even smaller measurable variations. Accuracy in polarimeters, encompassing ellipsometers and PLMs alike, is expressed as the fractional deviation of Mueller-matrix elements of a calibration sample from its theoretical truth, as demonstrated for a non-imaging narrowband laser polarimeter in Optics Express 24, 19881 (2016). Any polarimeter, ellipsometer, or PLM can be mathematically described as a partial Mueller-matrix polarimeter (pMMP), as taught in U.S. Pat. No. 10,540,571. Accuracy requirements and specifications for pMMPs apply to all measured Mueller-matrix elements.

Large-area micrographs are needed to characterize many materials, industrial parts, processes, and failures that exhibit large features or textures, where anything exceeding several mm is considered long or large. Finer textures also benefit from better statistics provided by large-area micrographs. Anisotropic material properties, for instance in crystalline or fibrous material, can extend over areas much larger than the FOVs of traditional optical microscopes. Many applications benefit from quantitative wide-field PLM (qwfPLM), as achieved by embodiments of the present invention, which provides better spatial visualization and statistics for applications including quality control and inspection of high-performance and safety-critical parts, for instance welds and forged aerospace parts.

Since most conventional microscopes have relatively small FOVs, specifically less than 100 mm², the term wide-field has been applied to many micrographs that are still significantly smaller than 100 mm², even though this is not large enough for statistically-relevant analyses of many common structures and textures. For such materials, parts, and processes, conventional micrographs collected as the sample is translated perpendicular to the optical axis are often stitched together to create a composite micrograph with a larger nominal FOV. While this approach allows visualization of larger areas, it also tends to highlight the limited intrinsic FOV of the microscope through the appearance of seam discontinuities where the individual micrographs are stitched together. Seam discontinuities are illustrated notionally in FIG. 1A based on a PLM crystallographic image. The microscope intrinsic FOV corresponds to one square block, 64 of which are stitched together in this example, and different hatchings represent different crystal orientations. Seam discontinuities are caused by aberrations and other gradients across the intrinsic FOV, such that the right edge (“R”) of the first (“1^{st}”) image does not match the left edge (“L”) of the second (“2^{nd}”), image, and so on, assuming the sample is translated to the left. Since aberrations generally occur as gradients across the intrinsic FOV, not just at the edges, the appearance of high-contrast seam discontinuities usually implies limited accuracy over a significant portion of the FOV. Image filters or digital-blending routines that can remove seam discontinuities generally cannot correct underlying gradients that affect much more than the edges of the micrograph. While a composite micrograph with seam discontinuities may be adequate for qualitative visualization, it is likely not accurate enough for quantitative microscopy, qPLM in particular, wherein the image is read by a computer and seam discontinuities can be mistaken for feature or grain boundaries. Seam discontinuities arise when stitching conventional brightfield micrographs and are particularly severe for polarization images, (see for example R J. Griffiths, et al., “Additive Friction Stir-Enabled Solid-State Additive Manufacturing for the Repair of 7075 Aluminum Alloy,” Appl. Sci. 9, 3486 (2019) and HE. Sims, “Process-Structure-Property Investigation of CP-Ti (Grade 2) Produced via High Deposition AM Laser Hot-Wire,” PhD Thesis, Case Western Reserve University (August 2022)), since polarization aberrations are typical but often neglected in the FOV specifications of conventional microscopes.

Based on the need for quantitative optical microscopy, and qPLM in particular, with sufficient accuracy (as discussed below) over FOVs exceeding 100 mm², and the inability of existing PLMs, due to their fundamental design geometries, to meet these requirements, there is a need for a new PLM design that avoids aberrations and achieves higher polarization accuracy over larger FOVs. Such a PLM is termed a quantitative wide-field PLM (qwfPLM), embodiments of which are described further herein.

The term polarization FOV is introduced, with its obvious meaning of the FOV over which a specified polarization accuracy prevails. Polarization-accuracy requirements vary with the material and application, with better than 5% usually needed and better than 1% needed for certain materials and applications. Materials with only mild anisotropy, for instance unetched martensitic steel, require very high polarization accuracy for successful qPLM.

The qwfPLM of one embodiment of the present invention produces more accurate (for instance better than 1%) polarization imaging over very large (for instance larger than 100 mm²) areas by placing the objective lens and any other aberrating optical components outside of the sample space, as illustrated in FIG. 2C. This design sacrifices spatial resolution, although embodiments of a qwfPLM described herein achieve resolution of about 5-microns or better for general reflective samples, with about 1-micron resolution or better possible for transmissive samples and for small reflective samples using a high-resolution attachment, according to another embodiment of the present invention. Conventional microscopes, on the other hand, sacrifice polarization accuracy in favor of high spatial resolution. The intrinsic polarization FOV captured by one embodiment of a qwfPLM is over 200× larger than polarization FOVs captured by typical commercial, The FOV produced by an embodiment of the qwfPLM can also be enlarged, with no fundamental limit, by stitching together micrographs collected as the sample or the microscope is translated.

Another embodiment of the present invention provides an auxiliary sample stage for placement of transmissive samples, for instance traditional histological and petrological slides, and a method for easily switching between reflective and transmissive samples, which is not possible in most commercial microscopes.

Embodiments of the present invention provide for a method to produce quantitative PLM (qPLM) over FOVs smaller than 100 mm² to 1 mm² and the associated micrographs. Since the new microscope suffers negligible polarization gradients over its intrinsic FOV, its on-axis micrographs may also be more accurate than those of conventional PLMs.

Embodiments of the present invention also encompass the micrographs and images produced by embodiments of a qwfPLM as disclosed herein. Visually or through material and process signature models these micrographs can reveal material chemistry, phase, crystallinity, topography, grain or fiber size and shape, crystal or fiber orientation, stress, other material or process properties, and their spatial and temporal distributions.

### BRIEF SUMMARY OF THE INVENTION

A first embodiment of the present invention is a polarized light microscope (PLM) comprising an electromagnetic radiation (EMR) source (for example a narrowband laser) that emits an illumination beam. An image capture device (ICD) (for example a digital ICD) is positioned on a bistatic path with the EMR source. For example, the bistatic path includes a bistatic angle of between about 5° to less than about 20°. A primary reflective sample plane is positioned at a vertex of the bistatic path between the EMR source and the ICD A sample space is bounded by the primary reflective sample plane and contains an adjacent contiguous portion of the bistatic path. A polarization state generator is positioned in the path of the illumination beam and outside of the sample space, between the EMR source and the primary reflective sample plane. The illumination beam follows a bistatic path. A polarization state analyzer is positioned on the bistatic path and outside of the sample space, between the primary reflective sample plane and the ICD. An objective lens is positioned outside of the sample space, between the polarization state analyzer and the image capture device on the bistatic path wherein the objective lens forms an image of the primary reflective sample plane at an image plane coincident with the image capture device. For example, in one embodiment, the objective lens is the only lens between the primary reflective sample plane and the image capture device. In a further example, the PLM has an instantaneous field of view (FOV) greater than about 5 mm² and less than about 300 mm² or for example the FOV is between about 100 mm² and about 300 mm². In a further example, the illumination beam is about 20-50mm in diameter or larger to realize the instantaneous FOV of about 100 mm² or greater. In one embodiment of the present invention, the PLM has an accuracy of about 5% or less, or about 2% or less, or about 1% or less overall elemental error in a measured partial Mueller matrix of a calibration mirror, at every pixel in the FOV satisfying the ICD functional pixel specification. The PLM of this first embodiment may further comprise one or more of the following: 1) a sample translation element to move the sample parallel to the primary reflective sample plane for imaging; 2) a calibration mirror, positioned coincident with the primary reflective sample plane, and 3) an auxiliary transmissive sample mount, positioned in the sample space between the primary reflective sample plane and the PSA, wherein the transmissive sample mount is constructed of flat non-aberrating windows and contains a transmissive sample plane; and/or 3) a calibration mirror, positioned coincident with the primary reflective sample plane, and a high-resolution attachment, positioned in the sample space between the primary reflective sample plane and the PSA, wherein the high-resolution attachment is constructed of flat non-aberrating mirrors and contains a secondary reflective sample plane.

A second embodiment of the present invention provides for a method to produce a polarization image (for example, a micrograph) of a sample area between about 50 mm² to about 300 mm², for example greater than about 100 mm² or less than about 300 mm² comprising the steps of: imaging a sample with a PLM (for example, a PLM of the first embodiment) wherein the sample area imaged is a single captured polarization image produced without stitching together smaller images. The second embodiment may further comprise stitching together a plurality of adjacent polarization images greater than about 50 mm² to produce a stitched polarization image greater than about 100 mm². For example, the plurality of adjacent polarization images stitched together produce an image with no or minimal seam discontinuities without the use of digital blending. In a further example, the stitching together the plurality of adjacent polarization images greater than about 50 mm² results from moving the sample relative to a fixed position of the PLM and/or the plurality of adjacent polarization images greater than about 50 mm² results from moving the PLM relative to the sample and the sample is in a fixed position.

A third embodiment of the present invention provides for a micrograph of a material sample imaged with the polarized light microscope (PLM), (for example a PLM of the first embodiment) wherein the micrograph is a single micrograph of an about 100 mm² to about 300 mm² area of the material sample produced without stitching together smaller images. For example, the PLM has an instantaneous FOV of between about 50 mm² to about 300 mm². In one example, the micrograph does not include seam discontinuities and wherein the micrograph is not stitched from multiple images.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIGS. 1A-B illustrates a depiction of a stitched crystallographic image produced by a conventional PLM that exhibits seam discontinuities (known in the art). FIG. 1B is a drawing of a grain-boundary map generated from the stitched image of FIG. 1A.

FIG. 1C is an illustration of a grain-boundary map generated from a PLM according to one embodiment of the present invention with a larger intrinsic polarization FOV as compared to the conventional PLM used to obtain the crystallographic image and the grain-boundary map generated in FIG. 1A-B.

FIG. 2A is a generic diagram of the optical configuration of a conventional monostatic reflective microscope.

FIG. 2B illustrates a conventional monostatic reflective PLM.

FIG. 2C illustrates a bistatic reflective PLM corresponding to one embodiment of the present invention.

FIG. 3 is an illustration of a qwfPLM according to one embodiment of the present invention.

### DETAILED DESCRIPTION OF THE INVENTION

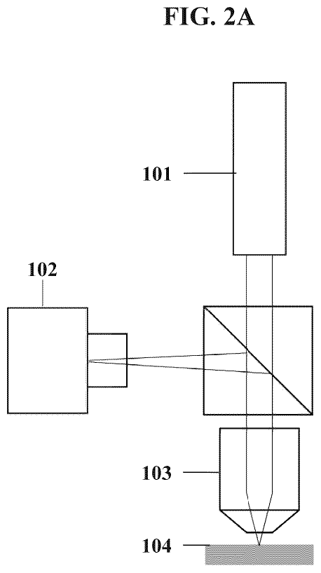

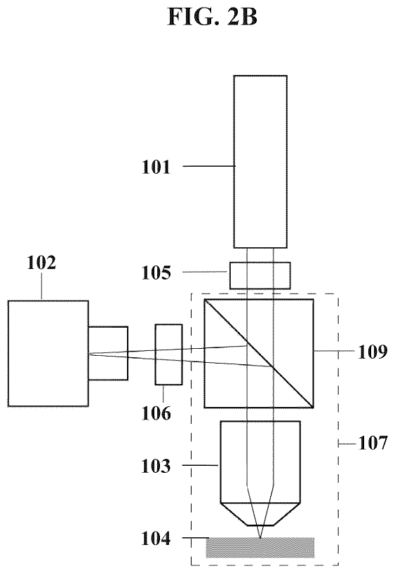

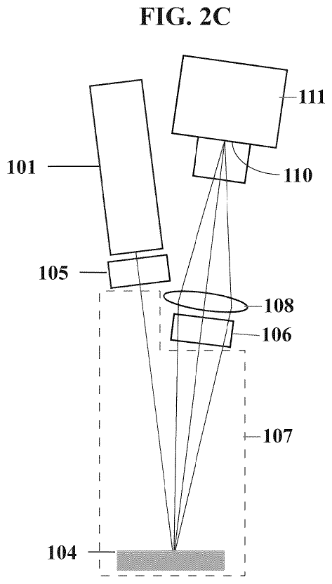

Conventional reflection optical microscopes utilize a monostatic, normal-incidence design as depicted in FIG. 2A. Referring now to FIG. 2A, a conventional reflection microscope comprises a source of electromagnetic radiation (EMR)101, which emits a beam that is directed to an objective lens 103 and focused on a sample surface 104 before returning to a beam splitter and detected by camera 102. This monostatic design can achieve high magnification and on-axis spatial resolution because the objective lens can be positioned very close to the sample.

Referring now to FIG. 2B, a conventional PLM is depicted wherein the objective lens 103 is in the sample space 107, between the two polarization modulators 105 and 106. The first polarization modulator 105, following the light source, is the polarization-state generator (“PSG”), and the second polarization modulator 106, following the sample, is the polarization-state analyzer (“PSA”). A beamsplitter 109 is also necessarily located in the sample space 107 of a monostatic PLM as well. Despite sophisticated and careful manufacturing, it remains very difficult to produce beamsplitters and objective lenses with exceptionally low polarization aberrations, especially for FOVs approaching 100 mm². In addition to inherent imperfections, small levels of mechanical stress and temperature gradients can cause polarization aberrations in these optical components.

One embodiment of the present invention is a qwfPLM having a bistatic design illustrated in FIG. 2C. EMR source 101 produces a beam (for example, visible light but not limited thereto) that is directed to a primary reflective sample plane 104 through PSG 105. PSG 105 is located outside of the sample space 107. The reflected EMR propagates from the sample plane 104 to PSA 106. PSA 106 is located outside of the sample space 107. The EMR propagates to the image capture device 111 through objective lens 108, and sample image plane 110 corresponds with the imaging plane of the image capture device. This bistatic design does not require a beamsplitter (which is not present and therefore not shown), and places the objective lens 108 outside the sample space 107. The embodiment illustrated in FIG. 2C therefore avoids aberrations from a beamsplitter and/or an objective lens of conventional microscopes. In one embodiment, the image capture device 111 of the embodiment of FIG. 2C may be tilted to coincide with the sample image plane 110, which may be inverted relative to the actual sample plane 104. Using polarization optics prequalified by a separate metrology polarimeter, as described for instance in Optics Express 24, 19881 (2016), to ensure the polarization optics meet the requirement of less than 1% overall elemental error in their Mueller matrices, in the design depicted in FIG. 2C provides a qwfPLM accurate to at least several percent, and preferably 1% or better, over a polarization FOV substantially larger than 100 mm². According to one embodiment, a qwfPLM of the present invention employs a narrowband laser light source to avoid chromatic polarization variations and aberrations. This embodiment uses neither a white light source nor a monochromator. Further, another embodiment uses only a single lens between the sample and the image capture device. Since the PLM of the present invention do not use a beamsplitter, it suffers less light loss, and as a consequence utilizes an EMR source of lower power as compared to conventional PLMs that employ a beamsplitter. As used herein, a sample can be a user-defined sample or a calibration mirror.

Other existing microscopes based on bistatic geometries, broadly termed oblique-illumination microscopy, are not designed and have not been demonstrated for quantitative PLM. Oblique illumination is often used, as a form of dark-field microscopy, to enhance the contrast of transparent samples or features. Combining images recorded under different oblique illuminations can also improve spatial resolution, but these techniques still suffer polarization aberrations if the objective lens and/or other optical components are located in the sample space. Light-sheet or selective plane-illumination microscopy, as described for instance in U.S. Pat. No. 8,582,203, employs a bistatic geometry to achieve tomographic imaging of thick samples, often based on fluorescent dyes, but is not designed for quantitative PLM. Several bistatic qPLMs have been demonstrated that retain the objective lens in the sample space, which limits their FOVs. The generalized-ellipsometer microscope demonstrated in Applied Optics 45(22), 5479(2006 ), and described in non-imaging form in U.S. Pat. No. 5,956,147, retains an objective lens in the sample space, limiting its polarization FOV to less than 100 mm². The FOV of this microscope is further limited by the intentional decentration of the illumination and reflected beams on the objective lens. The bistatic polarimeter described in US Pat. App. No. 2020/0271911 positions its objective lens (or “electromagnetic radiation collector”) between the sample and the PSA (or “second polarization modulator”), likewise limiting its polarization FOV. Placing the objective lens on the opposite side of the PSA would not increase the FOV of these PLMs if the clear aperture of the PSA is less than 100 mm², as is the case for PSAs based upon commercially available Photo Elastic Modulators (PEMs). Other generalized ellipsometers have been demonstrated for imaging and termed “imaging ellipsometers”, for instance as described in U.S. Pat. No. 7,663,752, but their FOVs are much smaller than 100 mm², in this case limited by the large bistatic angle, typically >50°, which they retain from traditional ellipsometry.

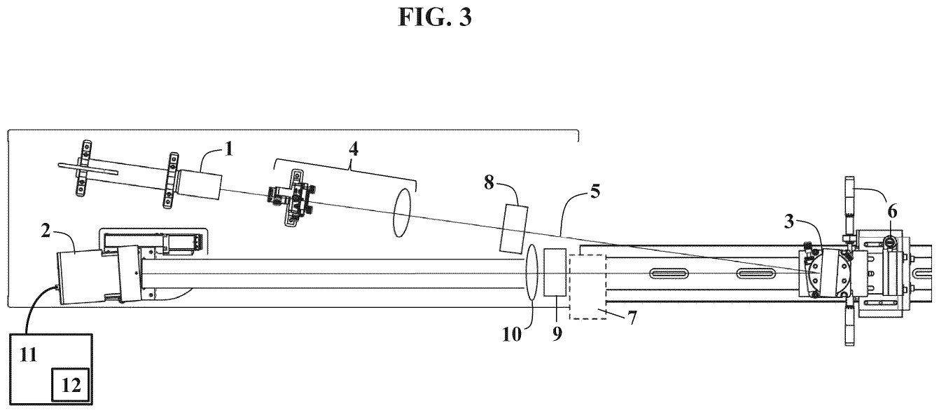

Referring now to FIG. 3, a top down view of an embodiment of a qwfPLM according to one embodiment of the present invention is illustrated. The qwfPLM comprises an EMR source (1), preferably a narrowband laser (1), positioned in a bistatic path with an image detector or image capture device (2) and a primary reflective sample plane (3) positioned there between. The bistatic angle is typically small, for instance 8°, but can be smaller or larger depending on the sizes of the optical components and the polarization effects to be measured. The qwfPLM further comprises expansion and collimation optics (4) to produce an expanded and approximately collimated beam (5) that illuminates the sample. The illumination beam can be between 20-50 mm in diameter to realize a large intrinsic FOV, or can be smaller. Larger effective FOVs are achieved by translating samples under the illumination beam, employing translation stages (6) on the sample assembly and stitching the resulting images together using digital image-processing routines. Due to its low-aberration design, the qwfPLM achieves stitched images with negligibleseam discontinuities, without the use of digital blending routines. In another embodiment of the present invention, suitable for use on immovable samples like in-service welds, stitched micrographs are created by translating the entire microscope, on a precision dolly, parallel to the sample surface.

If a reflective sample is highly polished, or metallographically polished, such that it reflects specularly (like a mirror), then the incident angle on the sample is half the bistatic angle, as illustrated in the embodiment of the qwfPLM of FIG. 3. Another embodiment of the present invention can be applied to rougher samples that reflect diffusely, in which case the incident angle can be variable in relation to the bistatic angle. For non-specular imaging of diffuse reflectors the image capture device is tilted to ensure it remains parallel to the image plane. In another embodiment, the microscope can be arranged to image transmissive samples by mounting a calibration mirror coincident with the primary reflective sample plane (3) and mounting a transmissive sample in an auxiliary/transmissive sample holder/mount (7) in the sample space close to the PSA (6).

By locating the objective lens outside the sample space, the qwfPLM of the present invention sacrifices resolution in order to achieve more accurate polarization imaging over very large areas. Conventional microscopes, on the other hand, sacrifice polarization accuracy in favor of high spatial resolution. The resolution of embodiments of the qwfPLM is about 5 microns, over the entire FOV regardless of stitching, which is fine enough for many applications. For applications that require finer resolution, another embodiment of the invention includes a high-resolution attachment, placed at the location of the auxiliary sample mount (7) depicted in FIG. 3. For small reflective samples, the high-resolution attachment can achieve resolution down to about 2 microns, and possibly sub-micron resolution. Resolution of about 2 microns or better is also achievable for transmissive samples of any size that do not obscure the illumination beam when placed in the auxiliary sample mount. The areas of the auxiliary sample mount and high-resolution attachment through which the reflected EMR passes can be constructed of flat, non-aberrating mirrors or windows only according to one embodiment.

The qwfPLM further comprises a first independent polarization modulator (8), embedded in the polarization-state generator (PSG)and configured to serially modulate the polarization state of the probe beam among a set of independent polarization states. The invention further comprises a second polarization modulator (9), embedded in the polarization-state analyzer (PSA)and mechanically independent of the first polarization modulator, followed by an objective lens (10). The PSA and objective-lens clear apertures are large enough to enable the required imaging resolution and FOV. The polarization modulators can be one of several established devices, for UV, visible, or IR light, for instance a polarization crystal, waveplate, or sheet mounted in a manual or preferably motorized rotary stage, or a sequence of such components, or two or more non-rotating polarization components mounted on a wheel or on a sliding linear stage, or a registered-channel multiplexer (RCM) as described in U.S. Pat. No. 10,540,571, which enables high-speed imaging up to video rate. In one or more embodiments the polarization modulator is not a photo-elastic modulator (PEM) or a sequence thereof. The combined settings of the first polarization modulator and the second polarization modulator are temporally-multiplexed and define multiple independent tunable polarization channels. The image capture device (“ICD”) (2), preferably a CCD or CMOS focal-plane array (FPA), is positioned to receive the light from the objective lens, wherein the image capture device produces a set of pixelated signals or images that are synchronized with the set of channels formed by the PSG and the PSA. Embodiments of the qwfPLM may further comprise a processor (11) connected and or in communication with one or more memories (12), which at least collects the raw images from the image capture device and stores and/or transmits them to storage. The processor and memory may be on-board or remote from the qwfPLM and communicate wirelessly or via a wired connection. The image capture device may also contain a large number of pixels, for example about 16,000 pixels, or about 16,000 to about 1,000,000 pixels or greater than about 1,000,000 pixels for example 50,000,000 pixels or greater. A suitable ICD provides a specification of the fraction of non-functional (dead and hot) pixels. A large number of pixels allows a large range of magnification(s) of a sample. In one embodiment of the present invention, the optical magnification is about 1 for the purpose of avoiding aberrations.

The qwfPLM according to one embodiment of the present invention is otherwise based on established optical designs utilizing commercial or custom lenses and mirrors, most of which are either polarization-preserving or precalibrated in order to eliminate systematic measurement errors. The precalibration standard and associated corrections, in particular as applied to the polarization-modulator components, distinguish another embodiment of the invention with a higher chance of achieving quantitative PLM.

Using qualified commercially-available polarization modulators, the intrinsic FOV of one embodiment of the qwfPLM is greater than 225 mm², and the FOV can be enlarged, with no fundamental limit, by stitching together micrographs collected as the sample is translated perpendicular to the bisector (horizontal in FIG. 2C) or by translating the microscope on a precision dolly. The low-aberration design ensures that these composite images do not suffer from seam discontinuities.

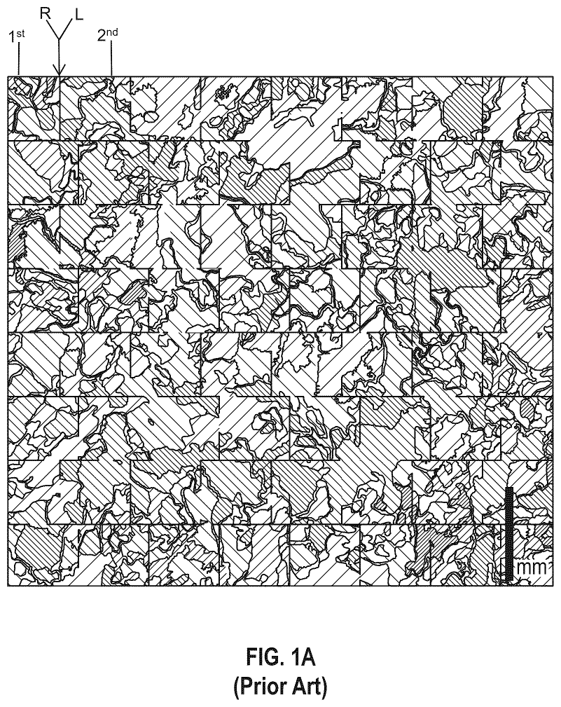

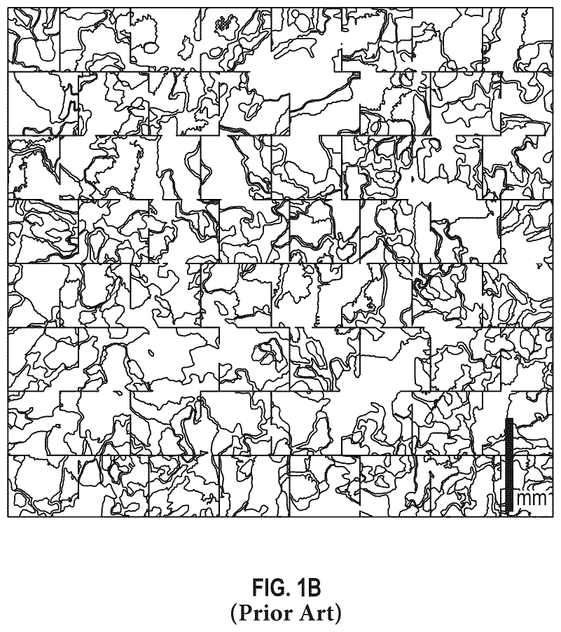

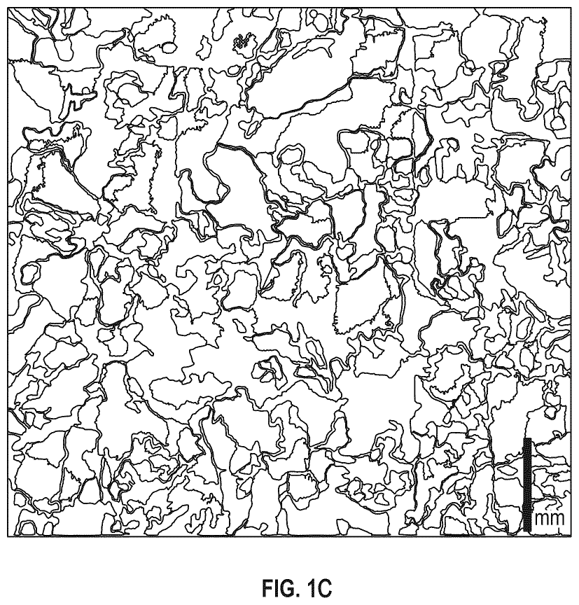

Seam discontinuities that appear in composite micrographs formed by stitching together images collected as the sample is translated can be applied to quantify the accuracy and quantitative FOV of a microscope. FIG. 1A depicts a stitched crystallographic image produced using a conventional PLM that exhibits seam discontinuities. The microscope intrinsic FOV corresponds to one square block, 64 of which are stitched together in this example, and different hatchings represent different crystal orientations. The seam spacing implies that the intrinsic FOV of this PLM is around 1 mm², far smaller than the 225 mm² intrinsic FOV of one embodiment of a qwfPLM of the present invention. Such conventional PLM micrographs are often applied for grain counting, wherein every substantial change in the crystal orientation is interpreted as a grain boundary (GB). For images with seam discontinuities, like FIG. 1A, in addition to the real GBs there will be false GBs at some of the seams, as depicted in FIG. 1B, so the estimated number of grains will be higher than the actual number of grains. An embodiment of a qwfPLM of the present invention, due to its low-aberration design, provides a much larger intrinsic (also referred to herein and equivalent to instantaneous) FOV and can measure the number of grains more accurately, as depicted in FIG. 1C, over much larger areas than a conventional PLM. The qwfPLM of the current invention eliminates or minimizes polarization aberrations, providing a significantly larger intrinsic FOV and eliminating or reducing to negligible levels seam discontinuities in stitched images.

As used herein “a”, “an”, “the” and “said” means one or more unless the context of the sentence otherwise indicates.

In at least one embodiment, and as readily understood by one of ordinary skill in the art, the apparatus according to the invention will include a general or specific purpose computer or distributed system programmed with computer software implementing the steps described above, which computer software may be in any appropriate computer language, including C++, FORTRAN, BASIC, Java, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements.

Note that in the specification and claims, “about” or “approximately” means within twenty percent (20%) of the numerical amount cited. All computer software disclosed herein may be embodied on any computer-readable medium (including combinations of mediums), including without limitation CD-ROMs, DVD-ROMs, hard drives (local or network storage device), USB keys, other removable drives, ROM, and firmware.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A polarized light microscope (PLM) comprising:
an electromagnetic radiation (EMR) source that emits an illumination beam;
an image capture device positioned on a bistatic path with the EMR source;
a primary reflective sample plane, positioned at a vertex of the bistatic path between the EMR source and the image capture device;
a sample space, bounded by the primary reflective sample plane and containing an adjacent contiguous portion of the bistatic path;
a polarization state generator, positioned outside of the sample space, between the EMR source and the primary reflective sample plane and in the path of the illumination beam;
a polarization state analyzer, positioned outside of the sample space, between the primary reflective sample plane and the image capture device and on the bistatic path; and
an objective lens, positioned outside of the sample space, between the polarization state analyzer and the image capture device on the bistatic path, which forms an image of the primary reflective sample plane at an image plane coincident with the image capture device.

2. The PLM of claim 1 wherein the PLM has an instantaneous field of view (FOV) greater than about 5 mm² and less than about 300 mm².

3. The PLM of claim 1 wherein the PLM has an instantaneous FOV between about 100 mm² and about 300 mm².

4. The PLM of claim 1 wherein the PLM has an accuracy of about 5% or less overall elemental error in a measured partial Mueller matrix of a calibration mirror.

5. The PLM of claim 1 wherein the EMR source is a narrowband laser.

6. The PLM of claim 2 wherein the illumination beam is about 20-50 mm in diameter or larger to realize the instantaneous FOV of about 100 mm² or greater.

7. The PLM of claim 1 wherein the bistatic path includes a bistatic angle of between about 5° to less than about 20°.

8. The PLM of claim 1 further comprising a sample translation element to move the sample parallel to the primary reflective sample plane for imaging.

9. The PLM of claim 1 wherein the image capture device is a digital image capture device.

10. The PLM of claim 1 wherein the objective lens is the only lens between the primary reflective sample plane and the image capture device.

11. The PLM of claim 1 wherein the primary reflective sample plane is at an arbitrary angle relative to the illumination beam and the image capture device is at an appropriate angle for coincidence with the image plane.

12. The PLM of claim 1 further comprising a calibration mirror, positioned coincident with the primary reflective sample plane, and an auxiliary transmissive sample mount, positioned in the sample space between the primary reflective sample plane and the PSA, wherein the transmissive sample mount is constructed of a flat non-aberrating window and contains a transmissive sample plane.

13. The PLM of claim 1 further comprising a calibration mirror, positioned coincident with the primary reflective sample plane, and a high-resolution attachment, positioned in the sample space between the primary reflective sample plane and the PSA, wherein the high-resolution attachment is constructed of flat non-aberrating mirrors and contains a secondary reflective sample plane.

14. A method to produce a polarization image of a sample area between about 50 mm² to about 300 mm² comprising:
imaging a sample with a PLM wherein the sample area imaged is a single captured polarization image produced without stitching smaller images of the sample area between about 50 mm² to about 300 mm².

15. The method of claim 14 wherein the PLM is the PLM of claim 1.

16. The method of claim 14 wherein the sample area captured in a single polarization image is less than about 300 mm².

17. The method of claim 14 wherein the sample area captured in a single polarization image is greater than about 100 mm².

18. The method of claim 14 further comprising stitching together a plurality of adjacent single captured polarization images greater than about 50 mm² to produce a stitched polarization image greater than about 100 mm².

19. The method of clam 18 wherein the plurality of adjacent single captured polarization images stitched together produce an image with no or minimal seam discontinuities without the use of digital blending.

20. The method of claim 18 wherein the plurality of adjacent single captured polarization images greater than about 50 mm² results from moving the sample relative to a fixed position of the PLM.

21. The method of claim 18 wherein stitching together the plurality of adjacent single captured polarization images greater than about 50 mm² results from moving the PLM relative to the sample and wherein the sample is in a fixed position.

22. The method of claim 14 wherein the polarization image is a micrograph.

23. A micrograph of a material sample imaged with the polarized light microscope of claim 1 comprising:
the micrograph produced by the polarized-light microscope of claim 1 wherein the micrograph is a single micrograph of an about 100 mm² to about 300 mm² area of the material sampleproduced without stitching together smaller images.

24. The micrograph of claim 23 wherein the PLM of claim 1 has an instantaneous FOV of between about 50 mm² to about 300 mm².

25. The micrograph of claim 23 wherein the micrograph does not include seam discontinuities.

26. The micrograph of claim 23 wherein the micrograph is not stitched from multiple images.
